(19) United States
(12) Patent Application Publication
(10) Pub. No.: US 2018/0077895 A1
(43) Pub. Date: Mar. 22, 2018

(54) PET BATHROOM PAD SYSTEMS AND METHOD

(71) Applicant: Janet Schulin, Katy, TX (US)

(72) Inventor: Janet Schulin, Katy, TX (US)

(21) Appl. No.: 15/481,311

(22) Filed: Apr. 6, 2017

Related U.S. Application Data
(60) Provisional application No. 62/396,795, filed on Sep. 19, 2016.

(51) Int. Cl. A01K 1/01; A01K 1/015

(52) U.S. Cl. CPC A01K 1/0107; A01K 1/0157

(57) ABSTRACT

A pet bathroom pad system includes a pad having a top surface, a bottom surface, and a thickness between the top surface and the bottom surface, and a periphery surrounding the thickness, and a sheet of waterproof laminate material affixed to the bottom surface. The pet bathroom pad system is useful for providing a non-leaking pet bathroom pad system for collecting and absorbing deposits of at least one pet.

### CROSS-REFERENCE TO RELATED APPLICATION

The present application is related to and claims priority to U.S. Provisional Patent Application No. 62/396,795 filed Sep. 19, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of pet pads and more specifically relates to a pet bathroom pad system.

### 2. Description of Related Art

Many people are afraid to leave their pet dog home alone because a dog may relieve themselves on household furnishings. Just one accident can ruin a carpet and cause an unpleasant smell to linger. This can lead to severe stress and anxiety on the part of the pet owner, who may opt to stay at home rather than deal with the repercussions of a dog that is left home alone. Potty pads are a great way for dogs to relieve themselves when owners are not home or unable to take them outside. Unfortunately, potty pads currently on the market allow urine to overflow and leak off the pad, creating a mess on the floor which is not desirable. Over time, this can damage the floors, requiring expensive repairs or floor replacements. A suitable solution is desired.

U.S. Pat. No. 8,656,863 to Mikael Havluciyan relates to a pet potty. The described pet potty includes a base plate and a grid. The base plate has a base and a wall along the perimeter of the base, the base and wall impermeable to fluid and forming a cavity capable of retaining fluid. The grid is sized to fit within the cavity of the base plate and has a complex of beams that can support a pet atop the grid. The beams have a top side and a bottom side, and substantially all of the beams are convex in shape on their top side.

### BRIEF SUMMARY OF THE INVENTION

In view of the foregoing disadvantages inherent in the known pet pads art, the present disclosure provides a novel pet bathroom pad system. The general purpose of the present disclosure, which will be described subsequently in greater detail, is to provide a pet bathroom pad system.

A pet bathroom pad system is disclosed herein. The pet bathroom pad system may include a pad having a top surface, a bottom surface, and a thickness between the top surface and the bottom surface, a periphery surrounding the thickness, and a sheet of waterproof laminate material affixed to the bottom surface. The pet bathroom pad system may comprise the pad; the pad having a body and a periphery; the periphery outlining the body. The body is defined by the top surface and the bottom surface being integrally joined via the thickness. The top surface of the pad comprises raised-interior-members protruding upwardly from the top surface to prevent spilling and overflow; the bottom surface placed atop and adjacent a substantially planar resting surface during use. The pad is configured to provide a non-leaking pet bathroom pad system for collecting and absorbing deposits of at least one pet.

The top surface of the pad preferably comprises vertically irregular, non-linear members periodically protruding upwardly from the top surface serving as channels to prevent spilling and overflow of the deposits from the pad. The top surface of the pad comprises vertically irregular, linear members protruding upwardly from the top surface to prevent spilling and overflow of the deposits. The non-linear, vertically irregular members may be (substantially) parallel to one another and extend about a length of the pad. The linear, vertically irregular members are parallel to one another and extend approximately a length of the pad and are equidistantly separated in preferred embodiments. The pet bathroom pad system may further comprise a top surface-raised-border extending along the periphery forming a cavity with the top surface configured to arrest fluid and prevent spilling and overflow. The pet bathroom pad system may further comprise a bottom surface-raised-border extending along the periphery of the pad forming a cavity with the bottom surface configured to arrest fluid flow and prevent leaking.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a pet bathroom pad system, constructed and operative according to the teachings of the present disclosure.

FIG. 1 is a perspective view of the pet bathroom pad system during an ‘in-use’ condition, according to an embodiment of the disclosure.

FIG. 2 is a perspective view of the pet bathroom pad system of FIG. 1, according to an embodiment of the present disclosure.

FIG. 3 is a perspective view of the pet bathroom pad system of FIG. 1, according to an embodiment of the present disclosure.

FIG. 4 is a perspective view of the pet bathroom pad system of FIG. 1, according to an embodiment of the present disclosure.

FIG. 5 is a bottom view of the pet bathroom pad system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to pet pads and more particularly to a pet bathroom pad system as used to provide a non-leaking pet bathroom pad system for collecting and absorbing deposits of at least one pet.

Generally, the embodiments described herein provide a dedicated place where pets can relieve themselves indoors. They greatly reduce the damage to home furnishings and carpet. The device may comprise super absorbent polymer (SAP), or hydrogel material, similar to that used in diapers to absorb urine that is contained in a porous material forming a pad (herein after referred to as a Potty Pad). Some non-limiting examples of SAP's include polyacrylamide copolymer, ethylene maleic anhydride copolymer, cross-linked sodium polyacrylate, carboxymethylcellulose, polyvinyl alcohol copolymers, cross-linked polyethylene oxide, and starch grafted copolymer of polyacrylonitrile. Embodiments described herein allow dog owners to leave the house with peace of mind.

The POTTY PAD is an absorbent pad for use inside the house upon which a dog may urinate when home alone and unable to venture outside. Certain embodiments may comprise a double-layered rectangular potty pad with raised border edges. There may also be a raised interior portion with configured as straight lines therein to help absorption, as well as a plastic backing to further protect floors. The space between the raised lines as well as the upraised portion around the border may contain an absorbent SAP or gel-lock material to absorb urine and prevent it from leaving the pad itself. The product may vary in size to accommodate dogs of all sizes. A Potty Pad quickly absorbs urine to prevent overflow. The Potty Pad may include an absorbent core to absorb fluids. To enhance absorbency, the pad may include a matrix of fluff material and chemical crystals, known as Super Absorbent Polymer (SAP), to soak up and trap fluid. The ‘fluff material’ may be made from wood pulp and may also include wheat/corn based materials, is to distribute the fluid, while the SAP is intended to absorb fluid and lock it in the core. In this way or suitable equivalent the present invention is able to physically/structurally and chemically deal with the pet deposits in the manner described.

Additionally, the Potty Pad can include an interior with vertically irregular or a wavy interior having raised portions for better absorption, as well as including a plastic backing to further protect floors on which they rest. The pad can include chemicals that emit a light grass scent (or the like) to attract and train dogs to use the pad thereby avoiding accidents around the home. The pad can be offered in assorted sizes to accommodate all dog breeds.

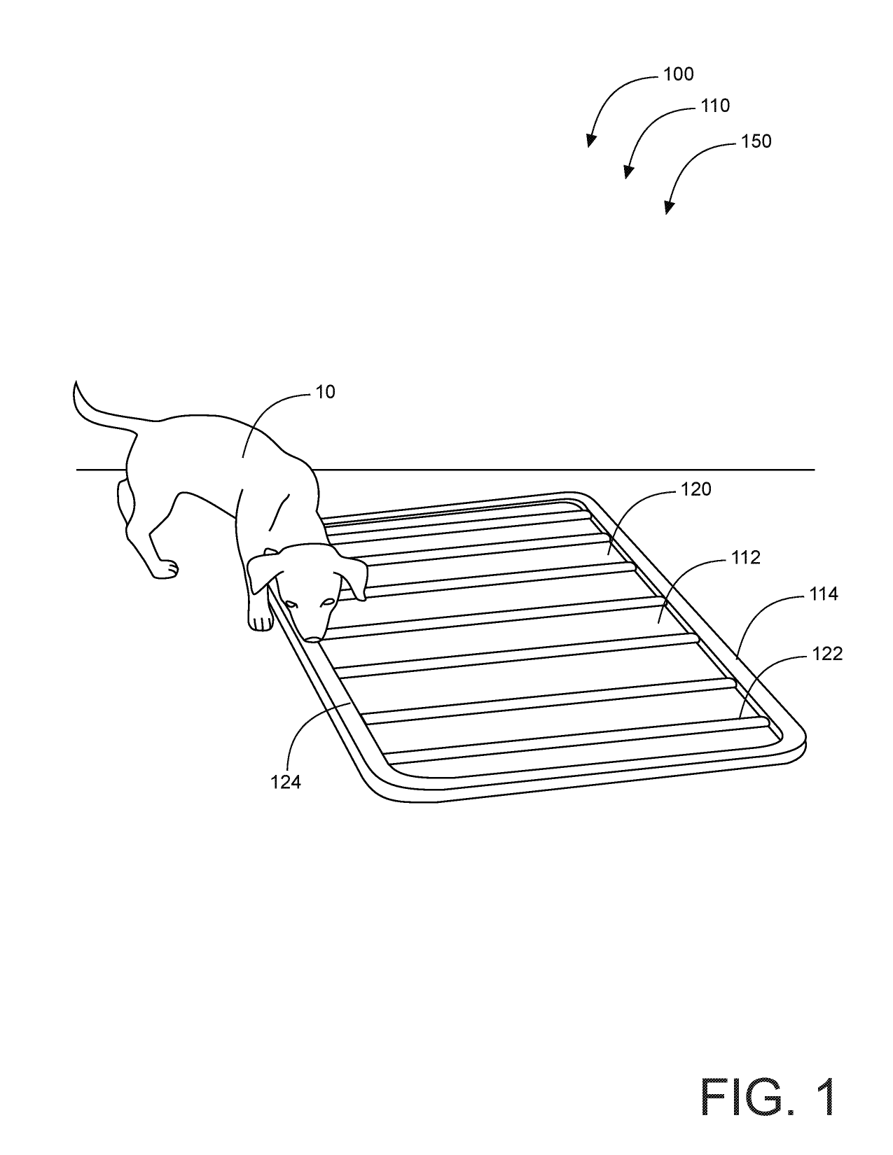

Referring now more specifically to the drawings by numerals of reference, there is shown in FIGS. 1-4, various views of a pet bathroom pad system 100. FIG. 1 shows a pet bathroom pad system 100 during an ‘in-use’ condition 150, according to an embodiment of the present disclosure. Here, the pet bathroom pad system 100 may be beneficial for use by a user 140 to provide a non-leaking the pet bathroom pad system 100 for collecting and absorbing deposits of at least one pet 10. As illustrated, the pet bathroom pad system 100 may include a pad 110 having a top surface 120, a bottom surface 130, and a thickness between the top surface 120 and the bottom surface 130, a periphery 114 surrounding the thickness, and a sheet of waterproof laminate material affixed to the bottom surface 130.

According to one embodiment, the pet bathroom pad system 100 may be arranged as a kit 105. In particular, the pet bathroom pad system 100 may further include a set of instructions 155. The instructions 155 may detail functional relationships in relation to the structure of the pet bathroom pad system 100 (such that the pet bathroom pad system 100 can be used, maintained, or the like, in a preferred manner).

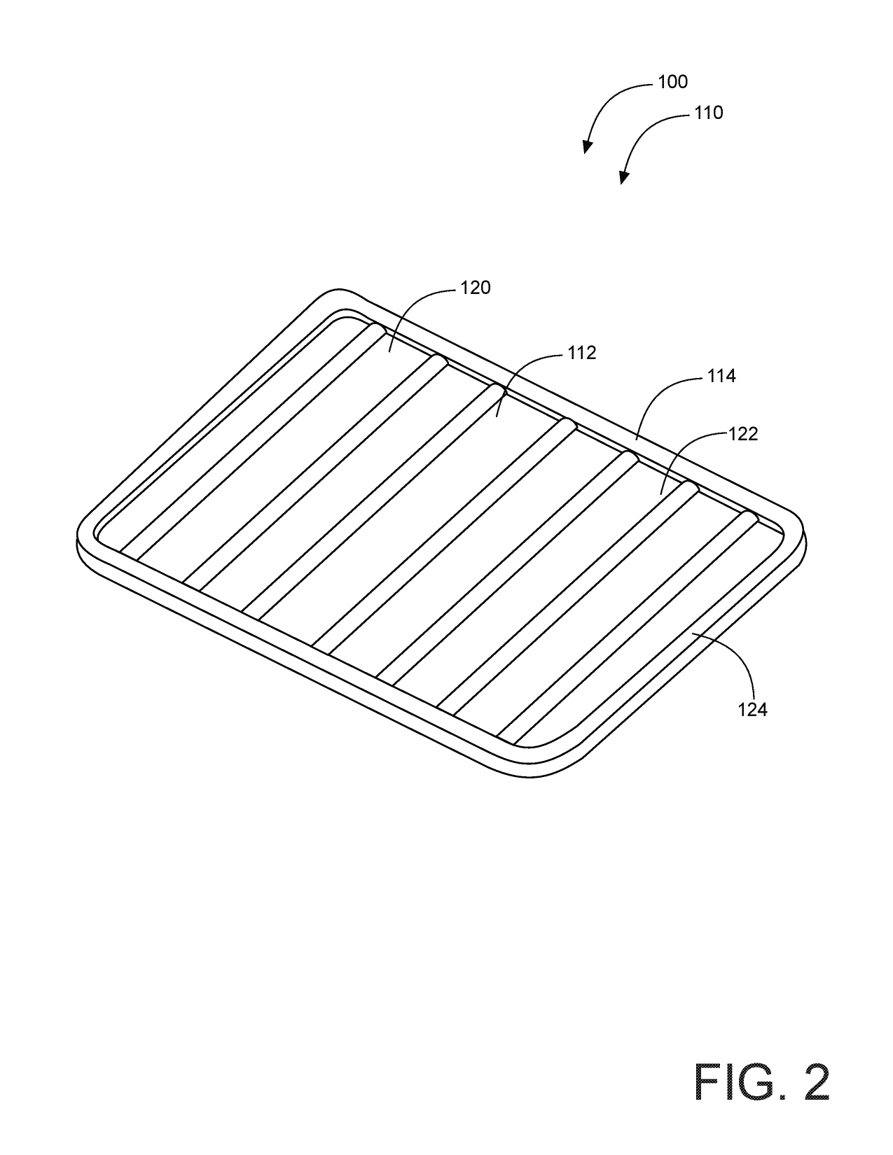

FIG. 2 shows the pet bathroom pad system 100 of FIG. 1, according to an embodiment of the present disclosure. As above, the pet bathroom pad system 100 may include the pad 110; the pad 110 having a body 112 and a periphery 114; the periphery 114 outlining the body 112. The body 112 is defined by the top surface 120 and the bottom surface 130 being integrally joined via the thickness. The top surface 120 of the pad 110 may comprise a raised-interior-members protruding upwardly from the top surface 120 to prevent spilling and overflow; the bottom surface 130 placed atop and adjacent a substantially planar resting surface during use (such as a floor for example). The pad 110 is configured to provide a non-leaking the pet bathroom pad system 100 for collecting and absorbing deposits of at least one pet 10.

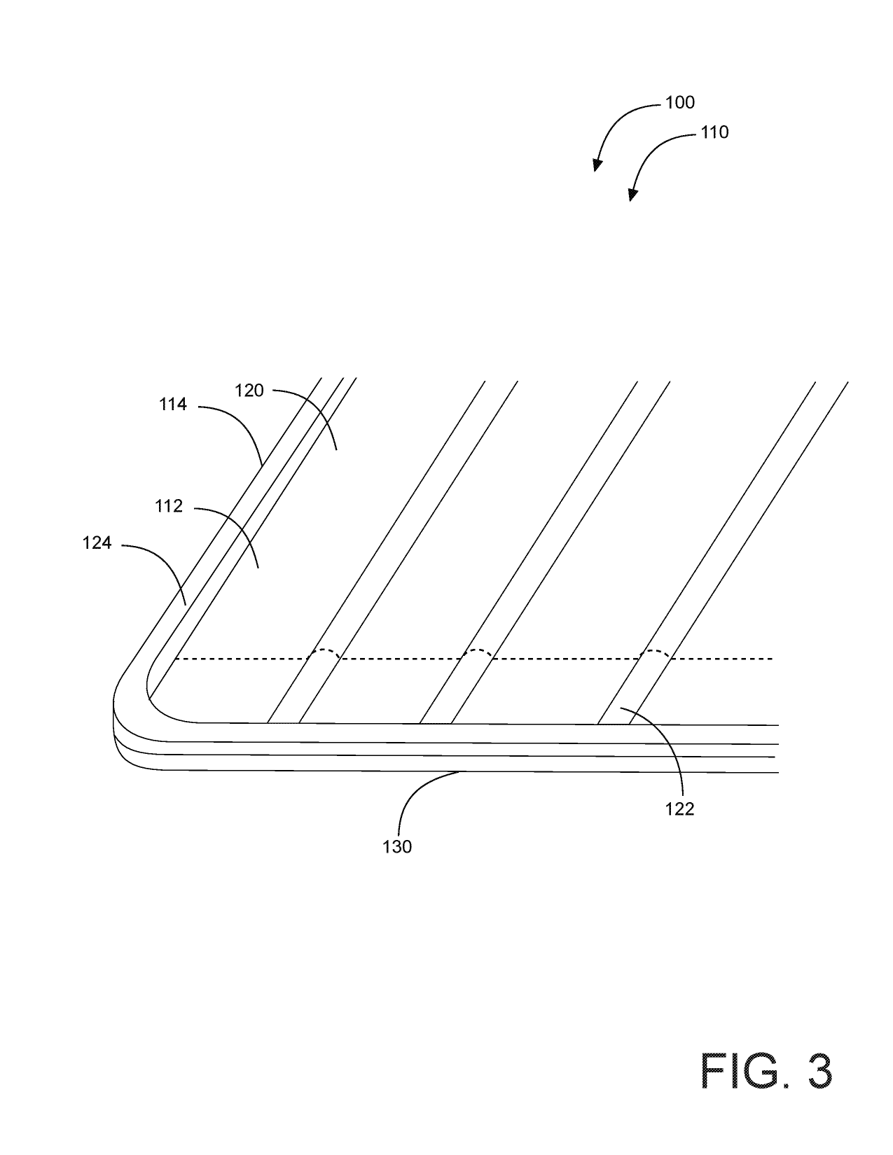

FIG. 3 is a perspective view of the pet bathroom pad system 100 of FIG. 1, according to an embodiment of the present disclosure. The top surface 120 of the pad 110 in preferred embodiments comprises vertically irregular, non-linear members 122 periodically protruding upwardly from the top surface 120 serving as channels to prevent spilling and overflow of the deposits from the pad 110. The top surface 120 of the pad 110 comprises vertically irregular, linear members 122 protruding upwardly from the top surface 120 to prevent spilling and overflow of the deposits. The non-linear, vertically irregular members 122 are parallel to one another and extend about a length of the pad. The linear, vertically irregular members 122 are parallel to one another and extend approximately a length of the pad 110 and are equidistantly separated in preferred embodiments.

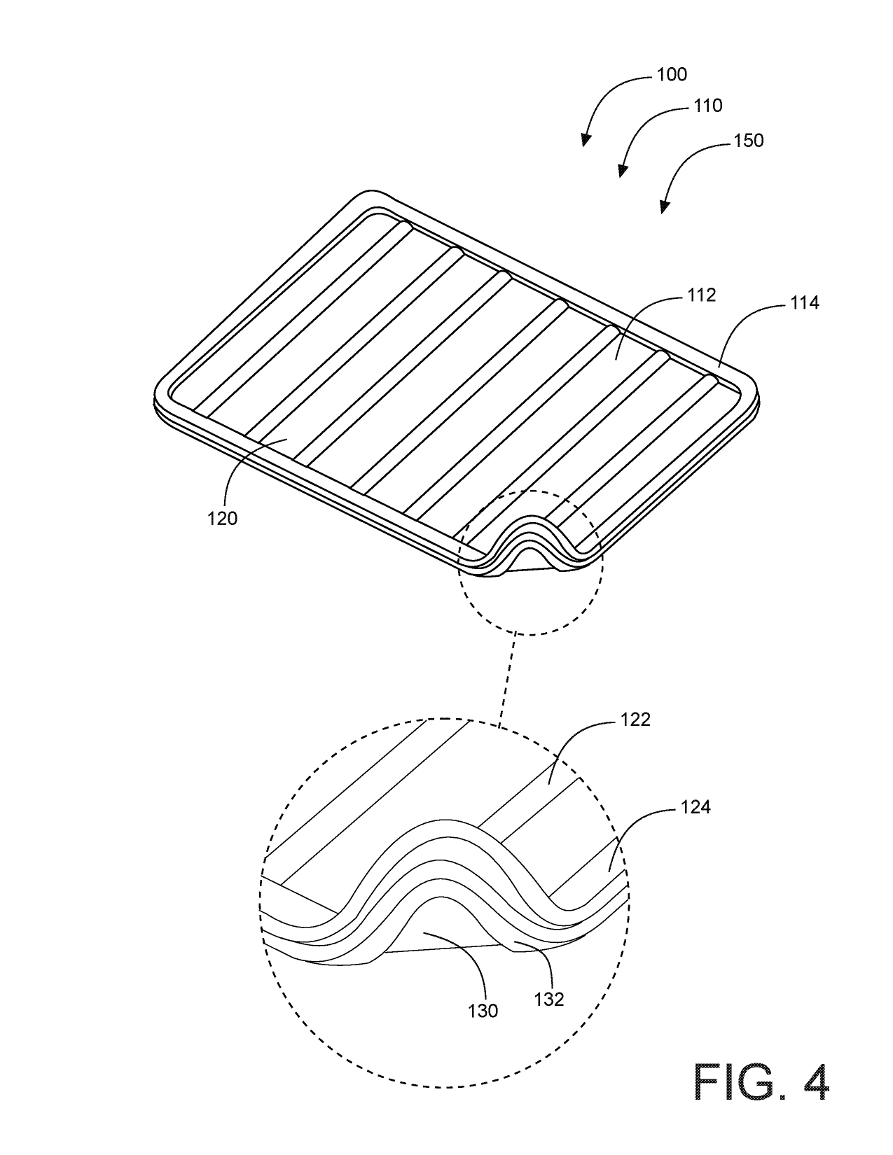

FIG. 4 is a perspective view of the pet bathroom pad system 100 of FIG. 1, according to an embodiment of the present disclosure. The pad 110 is single use and may be disposable. The bottom surface 130 comprises a plastic layer to minimize leaking. The periphery 114 of the pad 110 may comprise a rectangular profile. The pad 110 comprises super absorbent polymer (SAP) material suitable to absorb urine. The pad 110 releases at least one scent including grass to attract the pet 10 to use the pad 110 for urination and prevent accidents within a home. The pad 110 comprises a moisture wicking member configured to wick the deposits. The pad 110 comprises a double-layer flexible absorbent material in preferred embodiments. Other wicking means may be used.

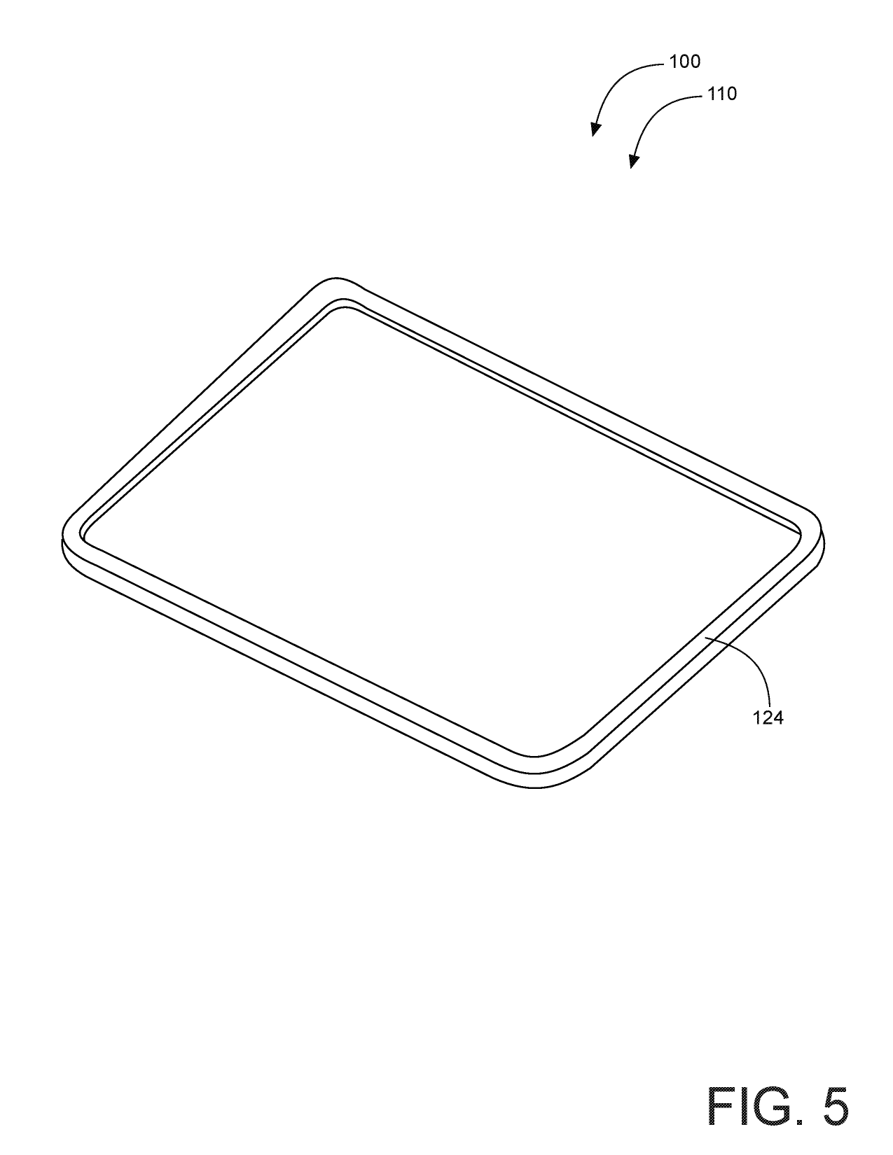

FIG. 5 is a bottom view of the pet bathroom pad system 100 of FIG. 1, according to an embodiment of the present disclosure. The pet bathroom pad system 100 may further comprise a top surface-raised-border 124 extending along the periphery 114 forming a cavity with the top surface 120 configured to arrest fluid and prevent spilling and overflow. The pet bathroom pad system 100 further comprises a bottom surface-raised-border 132 extending along the periphery of the pad 110 forming a cavity with the bottom surface 130 configured to arrest fluid flow and prevent leaking.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pet bathroom pad system, the system comprising:
a pad comprising;
a top surface;
a bottom surface; and
a thickness between the top surface and the bottom surface; and
a periphery surrounding the thickness, and
a sheet of waterproof laminate material affixed to the bottom surface.

2. The pet bathroom pad system of claim 1, wherein said top surface of said pad comprises vertically irregular, non-linear members periodically protruding upwardly from said top-surface.

3. The pet bathroom pad system of claim 1, wherein said top surface of said pad comprises vertically irregular, linear members protruding upwardly from said top surface to prevent spilling and overflow of said deposits.

4. The pet bathroom pad system of claim 2, wherein said non-linear, vertically irregular members are parallel to one another and extend about a length of said pad.

5. The pet bathroom pad system of claim 3, wherein said linear, vertically irregular members are parallel to one another and extend approximately a length of said pad.

6. The pet bathroom pad system of claim 1, wherein said vertically irregular members are equidistantly separated.

7. The pet bathroom pad system of claim 1, further comprising a top surface-raised-border extending along said periphery forming a cavity with the top surface configured to arrest fluid.

8. The pet bathroom pad system of claim 1, further comprising a bottom surface-raised-border extending along said periphery of said pad forming a cavity with the bottom surface configured to arrest fluid flow.

9. The pet bathroom pad system of claim 1, wherein said pad is single use.

10. The pet bathroom pad system of claim 1, wherein said periphery of said pad comprises a rectangular profile.

11. The pet bathroom pad system of claim 1, wherein said pad comprises super absorbent polymer (SAP) material suitable to absorb urine.

12. The pet bathroom pad system of claim 1, wherein said pad releases at least one scent.

13. The pet bathroom pad system of claim 12, wherein said scent is a grass scent.

14. The pet bathroom pad system of claim 1, wherein said pad comprises a moisture wicking member configured to wick said deposits.

15. The pet bathroom pad system of claim 1, wherein said pad comprises a double-layer flexible absorbent material.

16. The pet bathroom pad system of claim 1, wherein said pad is disposable.

17. A pet bathroom pad system, the system comprising:
a pad comprising;
a top surface;
a bottom surface; and
a thickness between the top surface and the bottom surface; and
a periphery surrounding the thickness, and
a sheet of waterproof laminate material affixed to the bottom surface;
wherein said top surface of said pad comprises vertically irregular, non-linear members periodically protruding upwardly from said top-surface;
wherein said top surface of said pad comprises vertically irregular, linear members protruding upwardly from said top surface to prevent spilling and overflow of said deposits;
wherein said non-linear, vertically irregular members are parallel to one another and extend about a length of said pad;
wherein said linear, vertically irregular members are parallel to one another and extend approximately a length of said pad;
wherein said vertically irregular members are equidistantly separated;
wherein said pad is single use;
wherein said periphery of said pad comprises a rectangular profile;
wherein said pad comprises super absorbent polymer (SAP) material suitable to absorb urine;
wherein said pad releases at least one scent;
wherein said scent is a grass scent;
wherein said pad comprises a moisture wicking member configured to wick said deposits; and
wherein said pad comprises a double-layer flexible absorbent material.

18. The system of claim 17, wherein the thickness comprises an absorbent layer of polysaccharide consisting of chains of glucose monomers and the plurality of raised interior members comprises absorbent material.
